(19) United States
(12) Patent Application Publication
(10) Pub. No.: US 2013/0224572 A1
(43) Pub. Date: Aug. 29, 2013

(54) Disc Battery Pressure-Activated Cap

(71) Applicant: Timothy M. Cassidy, Plymouth, MN (US)

(72) Inventor: Timothy M. Cassidy, Plymouth, MN (US)

(73) Assignee: BBY SOLUTIONS, Richfield, MN (US)

(21) Appl. No.: 13/404,630

(22) Filed: Feb. 24, 2012

(51) Int. Cl. H01M 2/34; B32B 37/12; H01M 2/08

(52) U.S. Cl. 429/174; 429/246; 156/292

(57) ABSTRACT

A pressure-activated dome switch is provided for a disc battery. The dome switch is electrically insulated from the positive and negative battery terminals. The dome switch can be combined with an insulator to completely isolate one of the battery terminals, thereby preventing creation of an electrical current while the switch is in its normally-off state. The dome switch may be attached to the disc battery with an electrically-insulating adhesive material. The dome switch may be attached to the disc battery by an insulating cap and insulated from the positive or negative battery terminals by an insulating washer. A method for manufacturing a disc battery with a dome switch is also provided.

### FIELD OF THE INVENTION

The present application relates to the field of disc batteries. More particularly, the described embodiments relate to an improved disc battery having a pressure-activated dome switch.

### BACKGROUND

Disc batteries, also called button batteries, are increasingly used to power small electronic devices. Their small size allows them to easily power remote controls, children's toys, watches, and many other small, portable devices. Although they are convenient, disc batteries can cause serious injury if accidentally swallowed, for example by a child or elderly adult. If a disc battery becomes lodged in the esophagus, the battery can cause irreversible tissue damage, and even death in rare instances. Although the mechanism of injury when swallowed is not fully understood, it has been established that a disc battery may cause esophageal burns in part by creating a current that hydrolyzes tissue fluids at a contact site, producing hydroxide at the negative electrode of the battery. Left untreated, the buildup of hydroxide can cause significant damage to the surrounding tissue.

### SUMMARY

A need exists for an improved disc battery that reduces the likelihood that an electric current is created if the disc battery is swallowed. Disc batteries are generally composed of a can that has a positive polarity; a top plate that has a negative polarity; an anode material such as zinc; cathode material such as silver oxide; electrolytes; and an insulating gasket that isolates the can from the top plate. In one aspect of the present invention, a disc battery is equipped with a pressure-sensitive dome switch that completely isolates the positive or negative electrodes in its regular state, but which allows an electrical current to be created when the dome switch is pressed. In another embodiment, a safety cap for a disc battery includes a pressure-sensitive dome switch that allows a current to be produced when the dome switch is pressed, and prevents creation of an electronic current when the dome switch is not pressed. A method for adhering a dome switch to a disc battery is also provided.

### BRIEF DESCRIPTION OF THE DRAWINGS

FIG. 1 is a cross-sectional view of one embodiment of a disc battery with a dome switch.

FIG. 2 is a cross-sectional view of a second embodiment of a disc battery with a dome switch.

FIG. 3 is an exploded view of a system with a cap and a dome switch for a disc battery.

FIG. 4 is a cross-sectional view of a disc battery having a dome switch attached to the disc battery with an electrically-insulating adhesive.

FIG. 5 is a flow chart of a method for bonding a dome switch to a disc battery.

### DETAILED DESCRIPTION

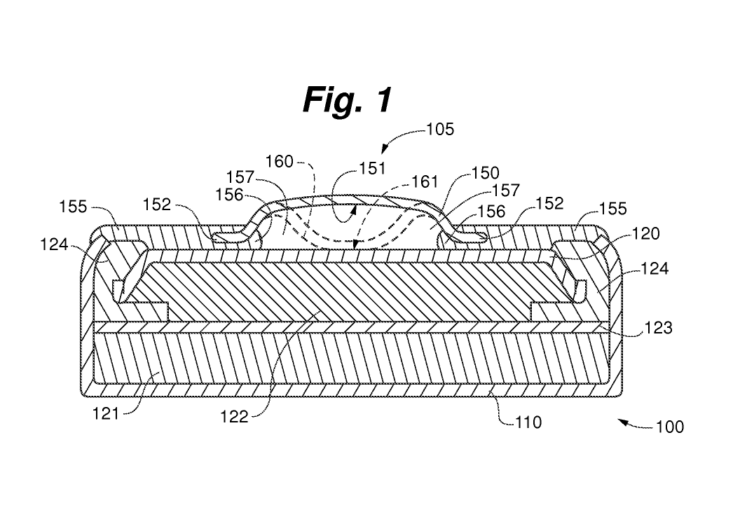

FIG. 1 shows a cross-sectional view of a first embodiment of a disc battery with a dome switch. Disc battery 100 comprises a metal can 110 that contains electrochemical material 121 that provides a positive polarity. Battery 100 also comprises a top plate 120 containing electrochemical material 122 that provides a negative polarity. Material 121 may include silver oxide, and material 122 may include zinc. Other suitable electrochemical battery materials may be used. Furthermore, although can 110 typically has a positive polarity and top plate 120 typically has a negative polarity, it is within the scope of the current disclosure for the polarities to be switched. A separator 123 separates materials 121, 122 and provides electrolytes to the battery 100. Insulating material 124 in the battery 100 prohibits an electrical connection between can 110 and top plate 120 when the battery 100 is not in use.

In the embodiment shown in FIG. 1, disc battery 100 is provided with a normally-off dome switch 150 that is insulated from can 110 and top plate 120 by insulator 155. Dome switch 150 is made of an electrically-conducting material, but because dome switch 150 is insulated from can 110 and top plate 120, no current flows when the dome switch 150 is in the default, off position. Dome switch 150 is actuated by applying force proximal to midpoint 151 of dome switch 150. When sufficient pressure is applied at midpoint 151, the position of dome switch 150 changes to position 160, (represented by dashed lines), and midpoint 151 contacts top plate 120 at contact point 161.

If the dome switch 150 were not present (as is the case with prior art disc batteries), an electronic device could draw power from the battery 100 by making contact with can 110 and top plate 120 to complete an electrical circuit. Because of the presence of the dome switch 150 and the insulator 155, the electronic device cannot make direct contact with the top plate 120. Instead, the electronic device makes electrical contact with the can 110 and the dome switch 150. When the dome switch 150 is not pressed, the switch 150 would not be in contact with the top plate 120 and the electronic device would not be able to draw power from the disk battery 100. When the dome switch 150 is pressed into position 160, the dome switch 150 contacts the top plate 120 at contact point 161, thereby allowing the electronic device to draw power from the battery through contact with the can 110 and the dome switch 150. Consequently, the electrical contacts of the electronic device preferably apply sufficient pressure to press the dome switch 150 into position 160 when the disc battery 100 is inserted into the device. This allows the device to draw power from the battery 100 when the battery 100 is inserted into the device, while allowing the dome switch 150 to isolate the top plate 120 and increasing the safety of the battery 100 when the battery 100 is not inserted into the device.

Dome switches are rated by the amount of force required to actuate the switch. This actuation force, known as trip force, is measured in grams. The dome switch 150 of the preferred embodiment preferably has a trip force that is high enough so that it will not usually be actuated when lodged in the esophagus, but low enough that it can be effectively actuated when placed in an electronic device. In the various embodiments of the current disclosure, the dome switch 150 is elevated above top plate 120 by insulator 155 at section 156. Dome switch 150 must be able to over-travel, that is, the contact point 151 of the actuating dome switch 150 must move beyond the flat plane formed by the base 152 of the dome switch 150 in order to make contact with the top plate 120.

Air pocket 157 creates a space between dome switch 150 and top plate 120. When dome switch 150 is actuated and in position 160, air pressure in air pocket 157 increases. The switch 150 can be “vented” to relieve this pressure increase by providing a venting path for the air between the air pocket 157 and the outside of the dome switch 150. One risk of venting is that, in a moist environment such as the esophagus, moisture could enter the air pocket 157 through the venting hole and create an electrical short between the dome switch 150 and the top plate 120. To completely insulate can 110 from top plate 120, the dome switch 150 preferably is not vented. The increased air pressure in air pocket 157 during actuation of a non-vented switch 150 will increase the trip force of dome switch 150 and must be taken into account during switch design. While the provision of a vent in dome switch 150 is not preferred, a dome switch with a sufficiently small vent will still provide an improvement over the prior art. A sufficiently small venting hole may resist the flow of liquid through the venting hole through surface tension, and thereby allow the venting of the air pocket 157 without a significant increase in the risk of a short between the dome switch 150 and the top plate 120. Furthermore, the insulation 155 has increased the distance between the can 110 and the dome switch 150 (shown in FIG. 1) when compared to the distance between the top plate 120 and can 110 without the presence of insulation 155 and switch 150. This correspondingly increases the resistance and decreases the current flow between the two electrodes in a semi-moist environment such as the human esophagus. This reduction in current flow should reduce the creation of hydroxide and increase the safety of the battery if swallowed.

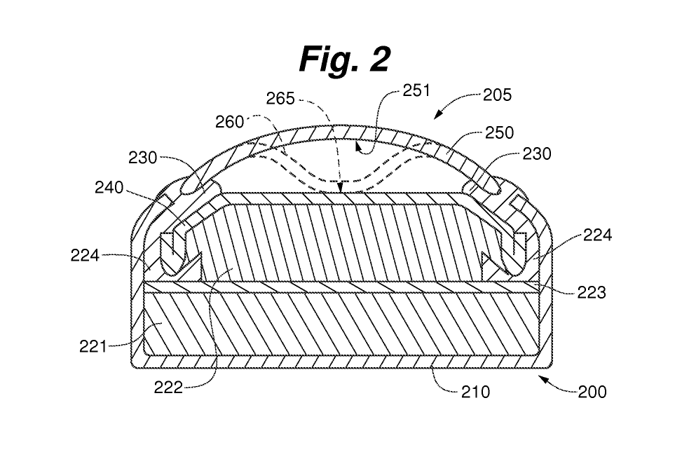

FIG. 2 provides a second embodiment of a disc battery 200 having a dome switch 250. Disc battery 200 comprises a can 210 containing electrochemical battery material 221, a separator 223, and top plate 240 containing electrochemical material 222. In the embodiment of FIG. 2, an electrically-conductive dome switch 250 is provided at the time battery 200 is manufactured. A single insulating gasket 224 electrically insulates can 210, top plate 240, and dome switch 250. Electrical current cannot flow in battery 200 unless dome switch 250 is actuated by providing pressure at midpoint 251 and contacting dome switch 250 to top plate 240 at point 265. As in the embodiment of FIG. 1, unless the switch 250 is vented, the trip force of dome switch 250 is affected by an increase in air pressure when dome switch 250 is in position 260.

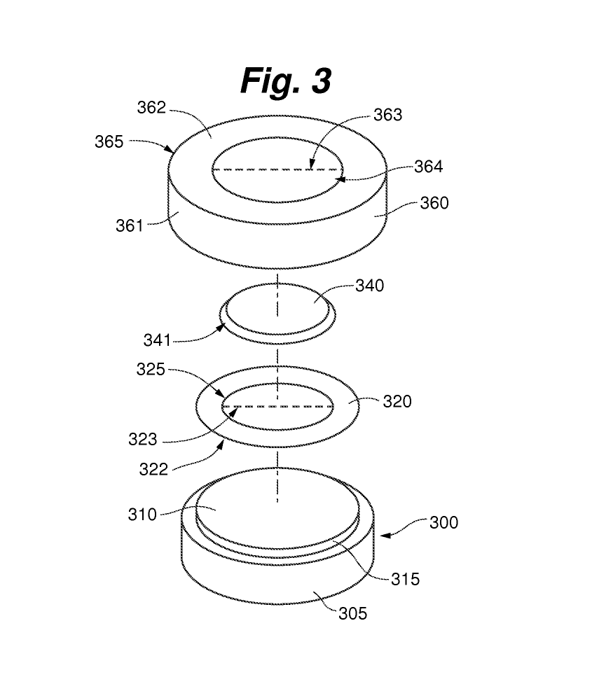

FIG. 3 shows another embodiment of a dome switch used with a disc battery. The exploded view of the system of FIG. 3 shows a battery 300 having a can 305, top plate 310, and insulator 315 that electrically insulates the electrodes. Can 305 is typically a positive electrode and top plate 310 is typically a negative electrode. The system of FIG. 3 may be advantageously utilized with a conventional, existing disc battery 300 to improve safety. An electrically-insulating washer 320 is centered over the top plate 310 of disc battery 300. Washer 320 is ring-shaped, and provides a gap 325 through which dome switch 340 may contact top plate 310. After washer 320 is placed on top of battery 300, dome switch 340 is centered over washer 320 and placed in position atop washer 320. Dome switch 340 has a lip 341 having a diameter that is larger than diameter 323 of gap 325. Dome switch 340 is thus electrically insulated from top plate 310 when dome switch 340 is in its normally-off position. An electrically-insulating cap 360 is centered over battery 300, washer 320, and dome switch 340. Cap 360 has a side wall 361, a top 362, and a gap 364. The inside diameter 363 of gap 364 is smaller than the diameter of lip 341, allowing cap 360 to hold dome switch 340 securely when cap 360 is placed over battery 300, washer 320, and dome switch 340. The outside edge 365 of cap 360 preferably fits very closely to can 305, providing a friction fit and preventing slippage.

When cap 360 is in place over the can 305 of the battery 300, the top plate 310 is electrically isolated from the environment outside the cap 360 and switch 340 combination. To draw power from the battery 300, an electrical device must contact both the bottom of the can 305 (which is left exposed by the cap 360) and the dome switch 340. Preferably, the electric device has a contact point that both makes contact with the dome switch 340 and provides sufficient pressure to activate the switch 340 by pressing the switch 340 into contact with the top plate 310 of the battery 300 through the gap 325 in washer 320.

The embodiment of FIG. 3 could be altered by turning battery 300 upside-down and placing washer 320 on the surface of can 305 opposite top plate 310. Washer 320 would then be disposed between can 305 and dome switch 340, and cap 360 would electrically isolate can 305 from the environment outside cap 360. In this alternate configuration the electric device would directly contact the top plate 305, then press the dome switch 340 to contact the can 305 through the gap 325 in washer 320.

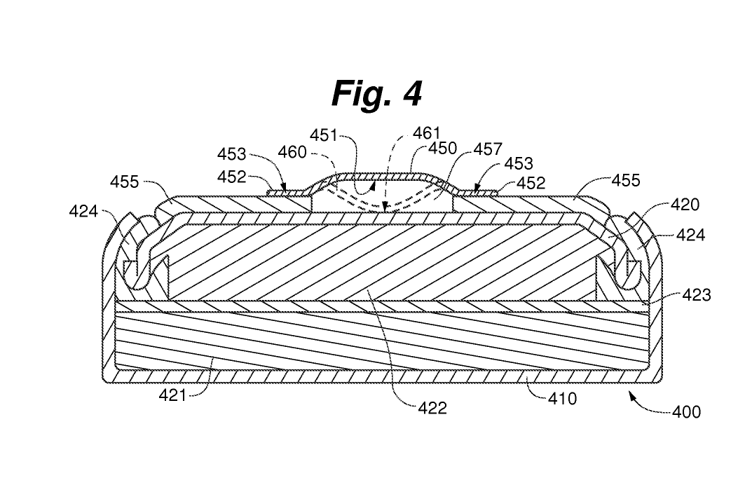

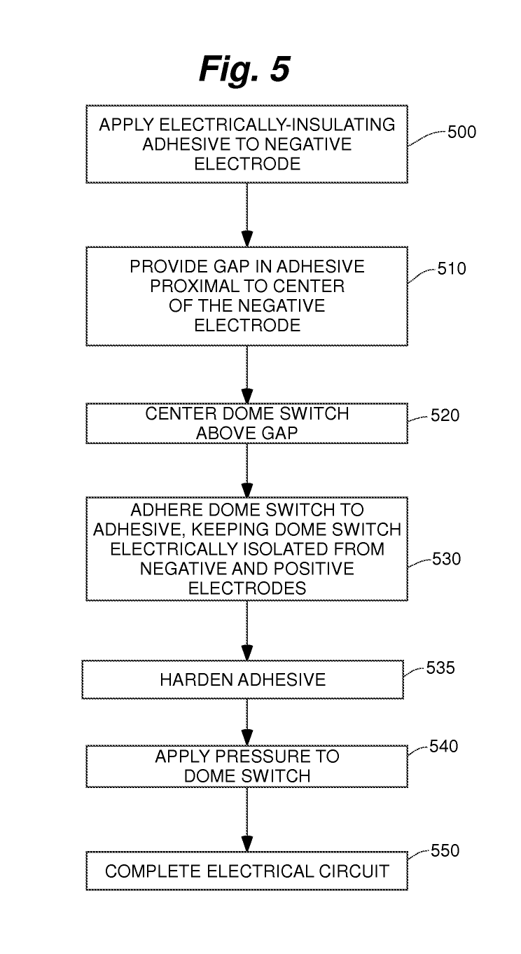

FIG. 4 shows a battery 400 having a dome switch 450. Dome switch 450 is attached to battery 400 via a process described in the flow chart of FIG. 5. Battery 400 comprises a can 410, separator 423, top plate 420, and battery insulator 424 for electrically insulating can 410 from top plate 420. Can 410 contains electrochemical material 421, and top plate 420 contains electrochemical material 422. Dome switch 450 is attached to battery 400 by an electrically-insulating adhesive 455 that is applied to top plate 420.

Referring to FIG. 5, in step 500 an electrically-insulating adhesive 455 is applied to top plate 420 of battery 400. The adhesive coats the edges of top plate 420 and abuts battery insulator 424. In step 510, a gap 457 is provided in the electrically-insulating adhesive 455 proximal to the center of top plate 420. Steps 500 and 510 can be performed in a single step by applying an annular layer of adhesive 455 to the top plate 420. By creating the layer of adhesive 455 in this manner, the adhesive 455 will electrically isolate top plate 420 from its environment except through gap 457. In step 520 the dome switch 450 is centered over the gap 457. In step 530, a lip 452 of dome switch 450 is adhered at site 453 of adhesive 455. In this step, a layer of adhesive 455 remains below the lip 452, thereby electrically isolating the dome switch 450 from top plate 420. In one embodiment, adhesive 455 is a physically hardening adhesive (such as a hot melt adhesive, an organic solvent adhesive, a plastisol adhesive, or a water-based adhesive), and the adhesive is hardened in step 535 after positioning the switch 450 to firmly secure dome switch 450 to battery 400. After dome switch 450 is adhered to adhesive 455 and adhesive 455 is hardened, battery 400 may be used to power an electronic device by applying pressure to dome switch 450 at midpoint 451, contacting dome switch 450 to top plate 420 at point 461, and then completing an electrical circuit.

The many features and advantages of the invention are apparent from the above description. Numerous modifications and variations will readily occur to those skilled in the art. For example, an electrically-insulating, but non-adhesive material could replace the electrically-insulating adhesive material of FIG. 4 if an additional adhesive is applied to secure both the top plate 420 and the switch 450 to the electrically-insulating material. Since such modifications are possible, the invention is not to be limited to the exact construction and operation illustrated and described. Rather, the present invention should be limited only by the following claims.

What is claimed is:

1. A disc battery comprising:
a) a positive electrode;
b) a negative electrode;
c) a dome switch positioned over a selected one of the positive and negative electrodes, the dome switch having an open position that is not in contact with the selected electrode, and a closed position that is in contact with the selected electrode; and
d) an insulating material that keeps the positive and negative electrodes and the dome switch all electrically insulated from each other when the dome switch is open.

2. The disc battery of claim 1, wherein the dome switch is approximately the same size as the selected electrode.

3. The disc battery of claim 1, wherein the dome switch is smaller than the selected electrode.

4. The disc battery of claim 1, wherein the insulating material is a single gasket.

5. The disc battery of claim 1, wherein the positive electrode is a can and the negative electrode is a top plate, wherein the selected electrode is the top plate.

6. The disc battery of claim 5, wherein the insulating material comprises an adhesive that attaches the dome switch to the top plate.

7. The disc battery of claim 6, wherein the adhesive is a physically hardening adhesive.

8. The disc battery of claim 7, wherein the insulating material further comprises a battery insulator surrounding the top plate, wherein the adhesive is annularly shaped extending from the battery insulator to a gap.

9. The disc battery of claim 8, wherein the gap in the adhesive is located proximal to the center of the top plate, further wherein the dome switch is centered over the gap.

10. The disc battery of claim 5, wherein the insulating material comprises a gasket battery insulator isolating the top plate from the can, and wherein the insulating material further comprises an annular insulator separating the dome switch from the top plate.

11. A battery cap system comprising:
a) a disc battery having a can and a top plate;
b) a dome switch having a dome-switch diameter;
c) an insulating washer disposed between and in contact with the top plate and the dome switch, the insulating washer having an inner washer diameter smaller than the dome-switch diameter such that the dome switch is not in electrical contact with the top plate;
d) an insulating cylindrical cap having a dome-switch hole having a diameter smaller than the dome-switch diameter, the cap sized to fit over the dome switch to hold it in place, and further sized to fit around the disc battery.

12. A method comprising:
a) applying an electrically-insulating adhesive to a top plate of a disc battery;
b) providing a gap in the electrically-insulating adhesive proximal to the center of the top plate;
c) adhering a dome switch to the electrically-insulating adhesive, the dome switch completely covering the gap; and
d) electrically isolating the dome switch from the top plate.

13. The method of claim 12, wherein the electrically-insulating adhesive fully electrically isolates the top plate other than at the gap in the electrically-insulating adhesive.

14. The method of claim 13, further comprising:
e) providing a downward force at the midpoint of the dome switch; and
f) completing an electrical circuit.

15. The method of claim 13, further comprising:
e) hardening the electrically-insulating adhesive.
